(19) United States
(12) Patent Application Publication
(10) Pub. No.: US 2026/0271125 A1
(43) Pub. Date: Sep. 10, 2026

(54) GROUP CONTEXT MANAGEMENT FOR USER EQUIPMENT COLLABORATION

(71) Applicant: QUALCOMM Incorporated, San Diego, CA (US)

(72) Inventors: Naeem AKL, San Jose, CA (US); Navid ABEDINI, Basking Ridge, NJ (US); Jianghong LUO, Skillman, NJ (US); Junyi LI, Greentown, PA (US)

(21) Appl. No.: 19/071,146

(22) Filed: Mar. 5, 2025

(51) Int. Cl. H04W 76/27; H04W 64/00

(52) U.S. Cl. CPC H04W 76/27; H04W 64/00

(57) ABSTRACT

Various aspects of the present disclosure generally relate to wireless communication. In some aspects, a user equipment (UE) collaboration group may include multiple UEs that may share wireless communication resources, parameters, or other suitable information to reduce latency, overhead, or power consumption, or to improve performance or throughput. In some aspects, one or more UEs in the UE collaboration group may indicate a context associated with the UE collaboration group to a network node such that the network node can support one or more collaboration scenarios associated with the UE collaboration group in various connectivity states. For example, the network node may facilitate or support sharing wireless communication resources, parameters, or other suitable information among the UEs in the UE collaboration group across connected, idle, inactive, or other connectivity states.

### FIELD OF THE DISCLOSURE

Aspects of the present disclosure generally relate to wireless communication and specifically relate to techniques, apparatuses, and methods associated with group context management for user equipment (UE) collaboration.

### BACKGROUND

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, or radio frequency (RF) sensing, among other examples. As the demand for connectivity continues to increase, further improvements in NR may be implemented, and other RATs, such as 6G and beyond, may be introduced to enable new applications and facilitate new use cases.

In some scenarios, multiple user equipments (UEs) may collaborate to share one or more resources, parameters, or other suitable information related to communication in a wireless network. For example, multiple collaborative UEs may share resources in a time, frequency, spatial, power, or other suitable domain, may share parameters related to network-level or device-level configurations, or may share other information such as measurements associated with one or more beam directions or one or more cells, among other examples. For example, in a scenario where multiple UEs share resources in a time domain (for example, for uplink transmission or downlink reception), a first UE may transmit or receive a message using a resource configured for a second UE, which reduces latency for the first UE when the resource configured for the second UE occurs earlier in time than a resource configured for the first UE. In another example, a first UE may obtain one or more configuration parameters associated with a procedure to establish a connection with a wireless network and share the parameters with a second UE, which may reduce signaling overhead because the network can avoid signaling the configuration parameters to the second UE and improve performance for the second UE by skipping one or more messages in the procedure. Accordingly, collaboration among multiple UEs may improve performance with respect to various key performance indicator (KPI) targets, such as reducing latency, reducing signaling overhead, reducing handover interruption times, reducing power consumption, increasing spectral efficiency, or increasing throughput, among other examples.

### SUMMARY

Some aspects described herein relate to a user equipment (UE). The UE may include a processing system that includes one or more processors and one or more code-storing memories coupled with the one or more processors. The processing system may be configured to cause the UE to communicate, within a UE collaboration group, information related to sharing one or more of a resource or a parameter associated with communication in a wireless network. The processing system may be configured to cause the UE to transmit, to a network node, an indication related to a collaboration context associated with the UE collaboration group, wherein the collaboration context is persistent across multiple connectivity states including one or more disconnected states associated with the wireless network.

Some aspects described herein relate to a network node. The network node may include a processing system that includes one or more processors and one or more code-storing memories coupled with the one or more processors. The processing system may be configured to cause the network node to receive an indication related to a collaboration context associated with a UE collaboration group sharing one or more of a resource or a parameter associated with communication in a wireless network, wherein the collaboration context is persistent across multiple connectivity states including one or more disconnected states associated with the wireless network. The processing system may be configured to cause the network node to configure an association among individual UE contexts for a set of UEs in the UE collaboration group in accordance with the collaboration context.

Some aspects described herein relate to a method for wireless communication by a UE. The method may include communicating, within a UE collaboration group, information related to sharing one or more of a resource or a parameter associated with communication in a wireless network. The method may include transmitting, to a network node, an indication related to a collaboration context associated with the UE collaboration group, wherein the collaboration context is persistent across multiple connectivity states including one or more disconnected states associated with the wireless network.

Some aspects described herein relate to a method of wireless communication performed by a network node. The method may include receiving an indication related to a collaboration context associated with a UE collaboration group sharing one or more of a resource or a parameter associated with communication in a wireless network, wherein the collaboration context is persistent across multiple connectivity states including one or more disconnected states associated with the wireless network. The method may include configuring an association among individual UE contexts for a set of UEs in the UE collaboration group in accordance with the collaboration context.

Some aspects described herein relate to a non-transitory computer-readable medium that stores a set of instructions for wireless communication by a UE. The set of instructions, when executed by one or more processors of the UE, may cause the UE to communicate, within a UE collaboration group, information related to sharing one or more of a resource or a parameter associated with communication in a wireless network.

The set of instructions, when executed by one or more processors of the UE, may cause the UE to transmit, to a network node, an indication related to a collaboration context associated with the UE collaboration group, wherein the collaboration context is persistent across multiple connectivity states including one or more disconnected states associated with the wireless network.

Some aspects described herein relate to a non-transitory computer-readable medium that stores a set of instructions for wireless communication by a network node. The set of instructions, when executed by one or more processors of the network node, may cause the network node to receive an indication related to a collaboration context associated with a UE collaboration group sharing one or more of a resource or a parameter associated with communication in a wireless network, wherein the collaboration context is persistent across multiple connectivity states including one or more disconnected states associated with the wireless network. The set of instructions, when executed by one or more processors of the network node, may cause the network node to configure an association among individual UE contexts for a set of UEs in the UE collaboration group in accordance with the collaboration context.

Some aspects described herein relate to an apparatus for wireless communication. The apparatus may include means for communicating, within a UE collaboration group, information related to sharing one or more of a resource or a parameter associated with communication in a wireless network. The apparatus may include means for transmitting, to a network node, an indication related to a collaboration context associated with the UE collaboration group, wherein the collaboration context is persistent across multiple connectivity states including one or more disconnected states associated with the wireless network.

Some aspects described herein relate to an apparatus for wireless communication. The apparatus may include means for receiving an indication related to a collaboration context associated with a UE collaboration group sharing one or more of a resource or a parameter associated with communication in a wireless network, wherein the collaboration context is persistent across multiple connectivity states including one or more disconnected states associated with the wireless network. The apparatus may include means for configuring an association among individual UE contexts for a set of UEs in the UE collaboration group in accordance with the collaboration context.

Aspects of the present disclosure may generally be implemented by or as a method, apparatus, system, computer program product, non-transitory computer-readable medium, user equipment, base station, network node, network entity, wireless communication device, or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example associated with user equipment (UE) collaboration in one or more disconnected states.

FIG. 4 is a diagram illustrating an example associated with UE collaboration in a connected state.

FIG. 5 is a diagram illustrating examples associated with UE collaboration without associating UE contexts at one or more network entities.

FIG. 6 is a diagram illustrating examples associated with indicating a collaboration context associated with a UE collaboration group to a network node to enable or more UE collaboration scenarios.

FIG. 7 is a diagram illustrating examples associated with establishing and indicating a UE group collaboration context to a network node to enable or more UE collaboration scenarios.

FIG. 8 is a diagram illustrating an example associated with transferring one or more contexts associated with a UE collaboration group after one or more UEs indicate a UE collaboration context to a network node.

FIG. 9 is a diagram illustrating an example associated with transferring one or more contexts associated with a UE collaboration group after one or more UEs indicate a UE collaboration context to a network node.

FIG. 10 is a diagram illustrating an example associated with storing contexts associated with a UE collaboration group at a common network entity.

FIG. 11 is a flowchart illustrating an example process performed, for example, at a UE or an apparatus of a UE that supports UE collaboration.

FIG. 12 is a flowchart illustrating an example process performed, for example, at a network node or an apparatus of a network node that supports UE collaboration.

FIG. 13 is a diagram of an example apparatus for wireless communication.

FIG. 14 is a diagram of an example apparatus for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures or functionalities in addition to or other than the structures or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As described herein, multiple UEs may collaborate to share one or more resources, parameters, or other suitable information related to communication in a wireless network, which may improve performance with respect to various key performance indicator (KPI) targets, such as reducing latency, reducing signaling overhead, reducing handover interruption times, reducing power consumption, increasing spectral efficiency, or increasing throughput, among other examples. However, in some examples, a network node may not know that different UEs are collaborating, which may result in a UE collaboration scenario failing or otherwise utilizing the shared resources, parameters, or other information in a suboptimal manner. For example, in a scenario where a network node does not know that multiple UEs are sharing downlink resources or occasions, the network node may be unable to send a downlink communication to a first UE using a downlink resource or occasion configured for a second UE. In another example, where a first UE shares parameters associated with a network procedure with a second UE, the network node may not provide the second UE with one or more resources (such as an uplink grant) that would allow the second UE to complete the network procedure. Accordingly, in scenarios where a network node has not associated the contexts for multiple UEs in a UE collaboration group, the collaboration scenario may not improve the relevant KPI targets to the optimal extent or the collaboration scenario may fail entirely or potentially degrade performance with respect to one or more targeted KPIs.

Various aspects relate generally to group context management for UE collaboration. Some aspects more specifically relate to one or more UEs indicating a collaboration context associated with a UE collaboration group to a network node, such that the network node may associate individual contexts for the UEs in the UE collaboration group and support the collaboration context associated with the UE collaboration group. For example, in some aspects, the collaboration context may include individual UE contexts associated with one or more UEs in the UE collaboration group or a group identifier associated with the various individual UE contexts. In some aspects, the collaboration context may include information related to a type of collaboration, such as a resource sharing scheme, a parameter sharing scheme, or another suitable use case for the collaboration within the UE collaboration group. In some examples, where the UE collaboration group is associated with a group identifier, an application server or other network entity may indicate the group identifier to each UE in the UE collaboration group, the UEs in the UE collaboration group may communicate to coordinate selecting the group identifier, or one UE in the UE collaboration group may obtain the group identifier from the network node and share the group identifier with other UEs in the UE collaboration group. In some aspects, after the collaboration context is indicated to the network node, one or more UE contexts may be transferred between network nodes such that contexts associated with different UEs are stored at a single network node. Additionally or alternatively, UEs in the collaboration group may indicate the collaboration context when registering on a wireless network, such that the same network entity is selected to store the contexts associated with all UEs in the collaboration group. In some aspects, additional techniques may relate to group context management may include authorizing the collaboration context and indicating the collaboration context periodically or when one or more events occur in order to maintain the collaboration context at the network, among other examples.

Particular aspects of the subject matter described in this disclosure can be implemented to realize one or more of the following potential advantages. In some examples, the described techniques can be used to associate contexts associated with multiple UEs in a UE collaboration group at one or more network nodes, which may allow a collaboration context associated with the UE collaboration group to persist across multiple connectivity states. For example, the described techniques may enable the collaboration context to persist across connected, idle, and inactive states, such that the collaboration context can be used to improve one or more targeted KPIs in connected or disconnected states. Furthermore, by storing contexts associated with multiple UEs in a UE collaboration group at a single network node or network entity, the described techniques can reduce backhaul signaling and associated overhead and reduce latency that may otherwise occur in scenarios where different UE contexts are distributed among different network nodes or network entities. Furthermore, by indicating the collaboration context to a network node, the network node can support the collaboration scheme(s) or collaboration scenario(s) associated with the UE collaboration group, which may improve KPIs such as latency, signaling overhead, handover interruption times, power consumption, spectral efficiency, throughput, or others depending on the collaboration scheme or scenario.

As described above, wireless communication systems may be deployed to provide various services, which may involve carrying or supporting voice, text, other messaging, video, data, or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies or support one or more of the foregoing use cases or new use cases.

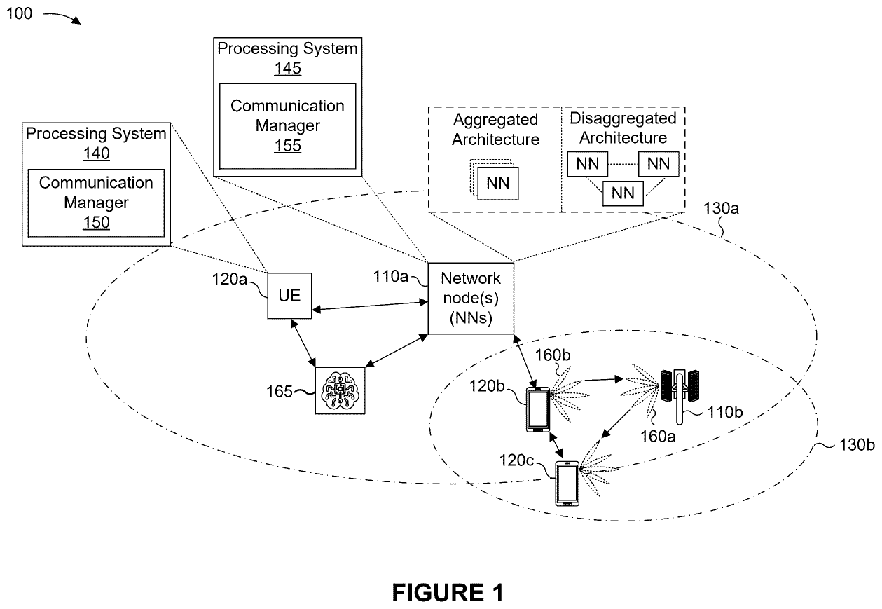

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, or that are included in mid-band frequencies. Similarly, the term “millimeter wave,” if used herein, may broadly refer to mid-band frequencies or to frequencies that are within FR2, FR4, FR4-a or FR4-1, FR5, or the EHF band. Higher frequency bands may extend 5G NR operation, 6G operation, or other RATs beyond 52.6 GHz.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 or the processing system 145 include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

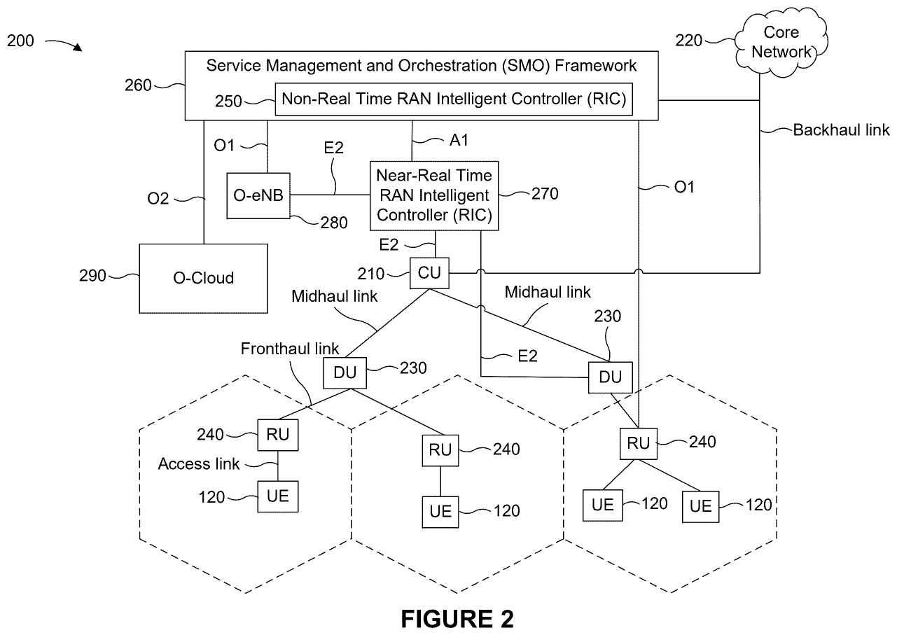

Alternatively, and as also shown, a network node 110 may be a disaggregated network node (sometimes referred to as a disaggregated base station), having a disaggregated architecture, meaning that the network node 110 may operate with a radio protocol stack that is physically distributed or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, or disaggregated network nodes, among other examples. Various different types of network nodes 110 may generally transmit at different power levels, serve different coverage areas (for example, a cell 130a and a cell 130b), or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, or any other suitable device or function that may communicate via a wireless medium.

Some UEs 120 may be classified according to different categories in association with different complexities or different capabilities. UEs 120 in a first category may facilitate massive IoT in the wireless communication network 100, and may offer low complexity or cost relative to UEs 120 in a second category. UEs 120 in a second category may include mission-critical IoT devices, legacy UEs, baseline UEs, high-tier UEs, advanced UEs, full-capability UEs, or premium UEs that are capable of

URLLC, eMBB, or precise positioning in the wireless communication network 100, among other examples. A third category of UEs 120 may have mid-tier complexity or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, or an NR-Lite UE, among other examples. RedCap UEs may bridge a gap between the capability and complexity of NB-IoT devices or eMTC UEs, and mission-critical IoT devices or premium UEs. RedCap UEs may include, for example, wearable devices, IoT devices, industrial sensors, or cameras that are associated with a limited bandwidth, power capacity, or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 or UE 120 may communicate using massive MIMO, multi-user MIMO, or single-user MIMO, which may involve rapid switching between beams or cells. For example, the amplitudes or phases of signals transmitted via antenna elements or sub-elements may be modulated and shifted relative to each other (such as by manipulating a phase shift, a phase offset, or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, or a vertical direction), a set of parameters that indicate one or more aspects of a directional signal, a direction associated with the signal, or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 or at the UE 120, such as in a network implementing mmWave technology. Massive MIMO may improve communication reliability by enabling a network node 110 or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state or a quasi co-location (QCL) parameter, among other examples. The network node 110 and the UE 120 may increase reliability or achieve efficiencies in throughput, signal strength, or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, or one or more servers, or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may communicate, within a UE collaboration group, information related to sharing one or more of a resource or a parameter associated with communication in a wireless network; and transmit, to a network node 110, an indication related to a collaboration context associated with the UE collaboration group, wherein the collaboration context is persistent across multiple connectivity states including one or more disconnected states associated with the wireless network. Additionally or alternatively, the communication manager 150 may perform one or more other operations described herein.

In some aspects, the network node 110 may include a communication manager 155. As described in more detail elsewhere herein, the communication manager 155 may receive an indication related to a collaboration context associated with a UE collaboration group sharing one or more of a resource or a parameter associated with communication in a wireless network, wherein the collaboration context is persistent across multiple connectivity states including one or more disconnected states associated with the wireless network; and configure an association among individual UE contexts for a set of UEs 120 in the UE collaboration group in accordance with the collaboration context. Additionally or alternatively, the communication manager 155 may perform one or more other operations described herein.

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

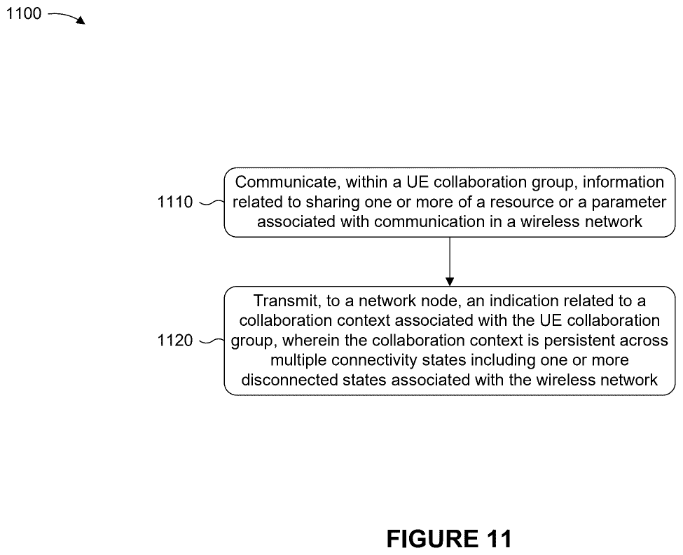

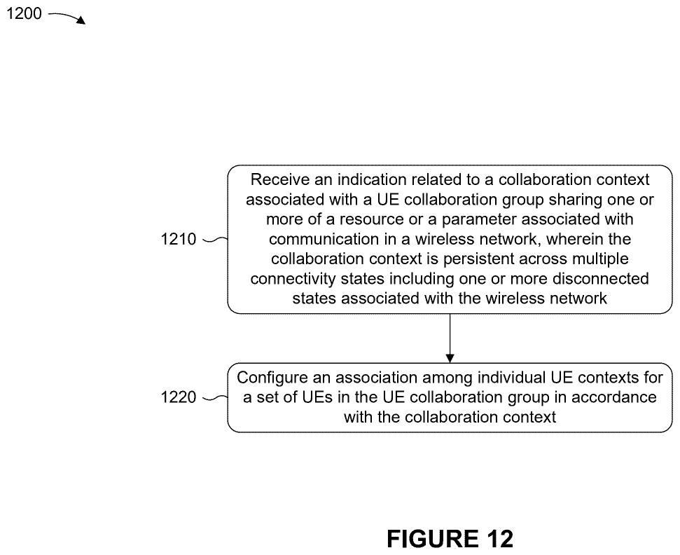

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with group context management for UE collaboration, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, or other processes as described herein. In some examples, executing instructions may include running the instructions, converting the instructions, compiling the instructions, or interpreting the instructions, among other examples.

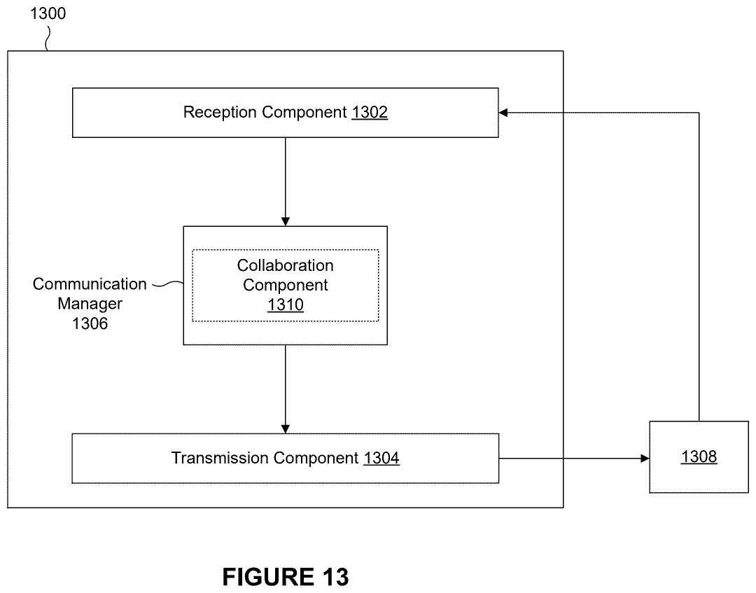

In some aspects, the UE 120 includes means for communicating, within a UE collaboration group, information related to sharing one or more of a resource or a parameter associated with communication in a wireless network; or means for transmitting, to a network node 110, an indication related to a collaboration context associated with the UE collaboration group, wherein the collaboration context is persistent across multiple connectivity states including one or more disconnected states associated with the wireless network. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

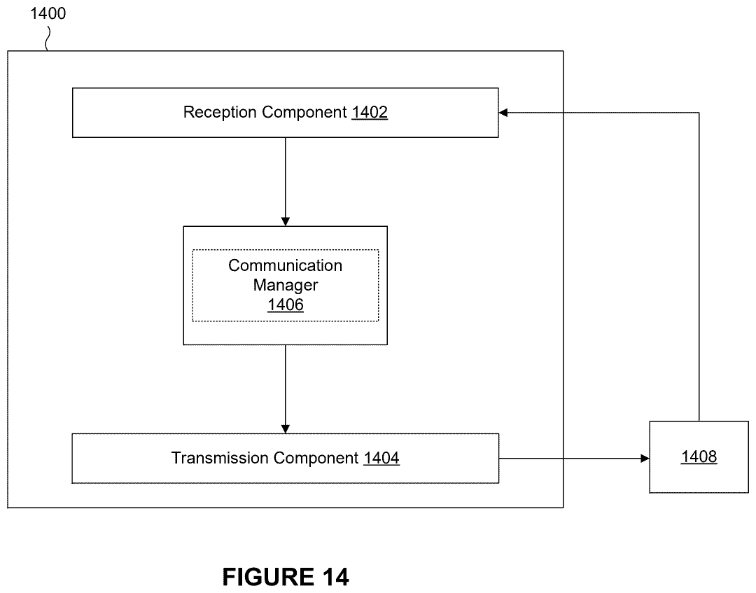

In some aspects, the network node 110 includes means for receiving an indication related to a collaboration context associated with a UE collaboration group sharing one or more of a resource or a parameter associated with communication in a wireless network, wherein the collaboration context is persistent across multiple connectivity states including one or more disconnected states associated with the wireless network; or means for configuring an association among individual UE contexts for a set of UEs 120 in the UE collaboration group in accordance with the collaboration context. The means for the network node to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

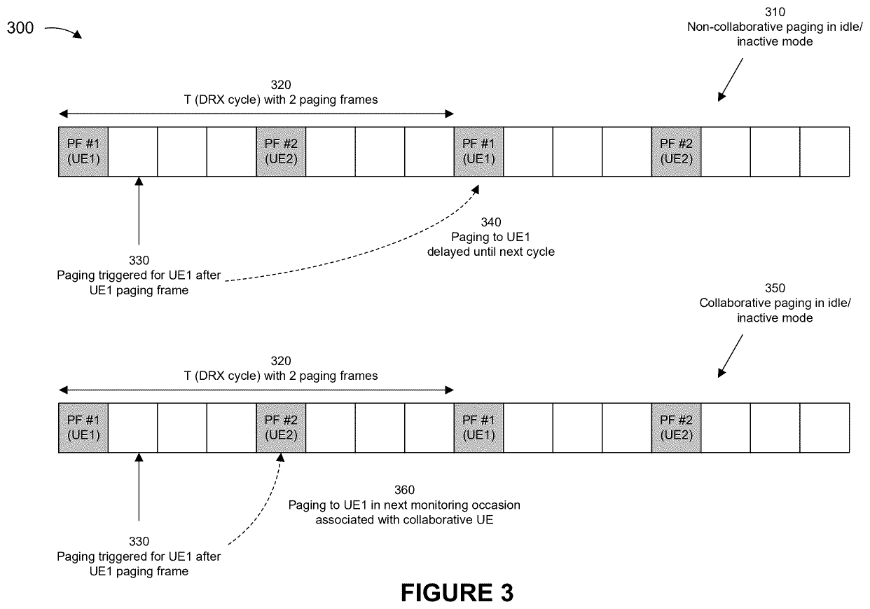

FIG. 3 is a diagram illustrating an example 300 associated with UE collaboration in one or more disconnected states. As described herein, FIG. 3 illustrates an example non-collaborative scenario 310 where multiple UEs (for example, a first UE and a second UE) are configured with separate resources related to a procedure that may be performed in a disconnected state (for example, an RRC idle or RRC inactive state), and an example collaborative scenario 350 where the multiple UEs 120 share resources related to the procedure performed in the disconnected state. For example, the non-collaborative scenario 310 and the collaborative scenario 350 are illustrated and described herein with respect to paging resources that may be used to a page a UE 120 in an idle or inactive state. However, the same or similar principles may apply to other suitable resources that may be configured for a UE 120 for one or more procedures performed when a UE 120 operates in a connected, idle, or inactive state.

As shown in FIG. 3, a network node 110 may configure a DRX cycle 320 that has a duration T with one paging frame per UE 120. For example, during the DRX cycle 320, the UE may generally remain in a low-power state (for example, an RRC idle or RRC inactive state) until a timer expires. When operating in the low-power state, the UE 120 may turn a receiver (for example, a main radio) off to conserve power. The low-power state may persist until the timer reaches an on duration, at which time the UE 120 may transition to an active state (for example, an RRC connected state) where the UE 120 monitors a downlink channel (for example, a paging frame) for incoming data. If the UE 120 detects a paging message or other relevant data in the paging frame, the UE 120 may process the information and respond accordingly, which may include operating in the active state for one or more non-paging frames. After the on-duration has expired or the communication has been processed, or if the UE 120 does not receive a communication in the paging frame, the UE 120 may transition to the low-power state and not monitor for any communications in non-paging frames. The DRX cycle 320 may repeat such that the UE 120 periodically operates in the low-power state to save power and in the active state to detect any paging messages directed to the UE 120.

As shown in FIG. 3, the DRX cycle 320 may include one or more paging frames (shown in a gray fill) and one or more non-paging frames (shown in a white fill). For example, the DRX cycle 320 may include a first paging frame for a first UE 120 (shown as UE1) and a second paging frame for a second UE 120 (shown as UE2) per DRX cycle 320. The duration and interval of the paging frames within the DRX cycle 320 may be fixed per UE 120 according to one or more paging configurations. For example, the position of paging frames within the DRX cycle 320 may be determined according to a unique identifier associated with each UE 120 (for example, the locations of the paging frames, which may include one or more paging occasions, within the DRX cycle 320, may be a function of a UE identifier). Configurations for the paging frames and/or paging occasions may be stored by a network node 110 to correspond with a specific UE 120. For example, in FIG. 3, the first frame in each DRX cycle 320 is a paging frame for the first UE 120, which is followed by three non-paging frames, and the fifth frame in each DRX cycle 320 is a paging frame for the second UE 120, which is also followed by three non-paging frames before the DRX cycle 320.

As described herein, each paging frame may correspond to a specific point in time when the corresponding UE 120 is scheduled to monitor a channel for a paging message directed to the UE 120, and each paging occasion may define an interval during which the UE 120 may expect to receive paging messages. In accordance with the DRX cycle 320, and to save power, each UE 120 may activate a receiver during the paging frame that includes the paging occasions associated with the UE 120 and otherwise deactivate the receiver during non-paging frames and paging frames that include paging occasions associated with other UEs 120. For example, in the paging configuration shown in FIG. 3, the first UE 120 monitors a channel for a paging message directed to the first UE 120 in the first paging frame in each DRX cycle 320 and otherwise operates in the low-power state during all other frames in the DRX cycle 320, and the second UE 120 monitors a channel for a paging message directed to the second UE 120 in the fifth paging frame in each DRX cycle 320 and otherwise operates in the low-power state during all other frames in the DRX cycle 320.

Accordingly, in the non-collaborative scenario 310, the network node 110 pages each UE 120 separately using the paging frame or paging occasion configured for the respective UE 120. For example, when paging is triggered for the first UE 120, the network node 110 transmits a paging message to the first UE 120 in the first frame in a DRX cycle 320. Similarly, when paging is triggered for the second UE 120, the network node 110 transmits a paging message to the second UE 120 in the fifth frame in a DRX cycle 320. However, paging each UE 120 using only the paging frame or paging occasion configured for that UE 120 may increase paging latency. For example, as shown in FIG. 3, paging may be triggered for the first UE 120 at a time 330 that is after the paging frame or paging occasion configured for the first UE 120. Accordingly, because the first UE 120 is operating in the low-power state at the time 330 when the paging is triggered, the network node 110 delays transmitting the paging message until a time 340 that corresponds to the first paging frame in the next DRX cycle 320.

Alternatively, in the collaborative scenario 350, the first UE 120 and the second UE 120 may share paging frames or paging occasions, such that the first UE 120 can be paged in the paging frame or paging occasion configured for the second UE 120 and the second UE 120 can be paged in the paging frame or paging occasion configured for the first UE 120. For example, in the collaborative scenario 350, the first UE 120 may monitor a channel for a paging message directed to the first UE 120 or the second UE 120 in the first paging frame in each DRX cycle 320 and otherwise operate in the low-power state during all other frames in the DRX cycle 320, and the second UE 120 may monitor a channel for a paging message directed to the first UE 120 or the second UE 120 in the fifth paging frame in each DRX cycle 320 and otherwise operate in the low-power state during all other frames in the DRX cycle 320. Accordingly, if the first UE 120 detects a paging message directed to the second UE 120 in the paging frame or paging occasion configured for the first UE 120, the first UE 120 may notify the second UE 120 (for example, using a wakeup signal). Similarly, if the second UE 120 detects a paging message directed to the first UE 120 in the paging frame or paging occasion configured for the second UE 120, the second UE 120 may notify the first UE 120. In this way, when paging is triggered for the first UE 120 at time 330, the network node 110 may transmit the paging message directed to the first UE 120 at a time 360 that corresponds to the paging frame configured for the second UE 120. As a result, the paging latency may be reduced in the collaborative scenario 350.

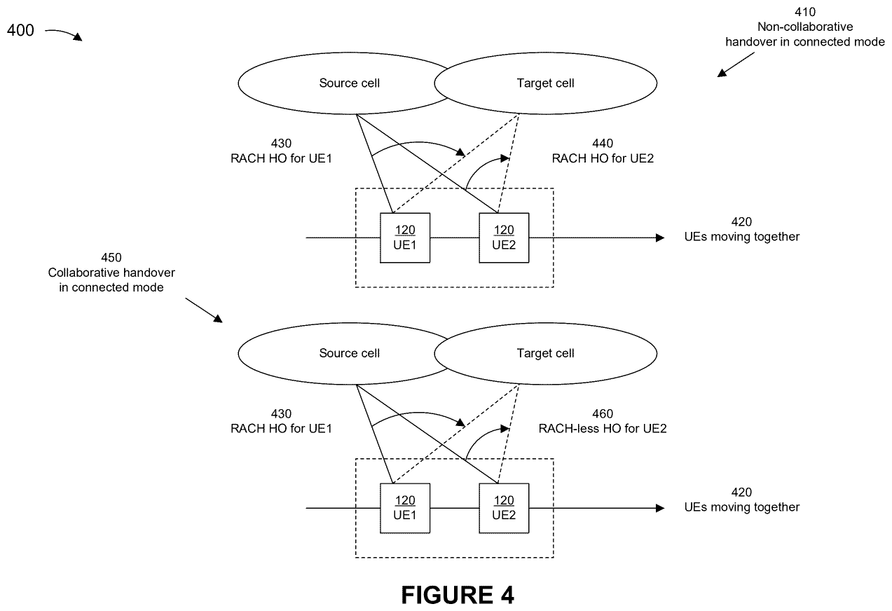

FIG. 4 is a diagram illustrating an example 400 associated with UE collaboration in a connected state. As described herein, FIG. 4 illustrates an example non-collaborative scenario 410 where multiple UEs (for example, a first UE and a second UE) are each configured with one or more parameters related to a procedure that may be performed in a connected state (for example, an RRC connected state), and an example collaborative scenario 450 where the multiple UEs 120 share parameters related to the procedure performed in the connected state. For example, the non-collaborative scenario 410 and the collaborative scenario 450 are illustrated and described herein with respect to parameters used in a handover procedure that a UE 120 may perform in a connected state. However, the same or similar principles may apply to other suitable parameters that may be configured for a UE 120 for one or more procedures performed when a UE 120 operates in a connected, idle, or inactive state.

As described herein, a handover procedure maybe used in a wireless network to maintain seamless connectivity when a wireless link between a UE 120 and a serving cell becomes degraded or a wireless link to a neighbor cell improves or becomes better than the serving cell. For example, a UE 120 may be configured to obtain measurements for one or more parameters that relate to channel quality associated with the serving cell and one or more neighbor cells and to provide the measurements to the serving cell. The serving cell then determines whether a handover to a target (neighbor) cell may be needed according to the measurements provided by the UE 120. In cases where the serving cell determines that a handover to a target cell is needed, the serving cell (or source cell) communicates with the target cell to prepare for the handover, sends a handover command to the UE 120 to instruct the UE 120 to disconnect from the source cell and connect to the target cell, and releases network resources allocated to the UE 120 when the handover is successful and the connection to the target cell is confirmed. For example, in order to connect to the target cell, the UE 120 may perform a RACH procedure in the target cell to synchronize with the target cell. Alternatively, in Layer 1 or Layer 2-triggered mobility (also known as lower-layer triggered mobility) (LTM), the UE 120 may perform early synchronization with the target cell (before any handover is triggered), such that a RACH-less handover can be triggered using L1/L2 signaling (for example, DCI or a MAC-CE) to reduce handover latency.

In general, a handover is managed in accordance with various parameters. For example, a network node 110 may provide a UE 120 with an RRC configuration that indicates configured values for various mobility parameters, such as values for one or more thresholds that are used to evaluate serving cell measurements and/or neighbor cell measurements, one or more hysteresis parameters that define margins to stabilize handover decisions and avoid frequent and/or unnecessary handovers that result from short-term fluctuations in signal strengths, and/or one or more time-to-trigger (TTT) parameters that define a delay between a time when a handover condition is satisfied and a time when the handover is triggered or initiated to further ensure that handovers are triggered only when necessary. For example, a measurement report may be triggered, or a handover condition may be satisfied, when a serving cell measurement fails to satisfy a threshold, when a difference between a neighbor cell measurement and a serving cell measurement satisfies a threshold, when a neighbor cell measurement satisfies a threshold, and/or when a serving cell measurement fails to satisfy a first threshold and a neighbor cell measurement satisfies a second threshold, among other examples. In some cases, each event that triggers a measurement report or satisfies a handover condition may be associated with one or more mobility parameters, such as values for the relevant threshold, hysteresis, offset, and/or TTT. Furthermore, a UE 120 may obtain a timing advance value to use when transmitting one or more messages to the target cell to ensure that the target cell detects the one or more messages.

In some aspects, as described herein, multiple UEs 120 may collaborate with one another to share one or more parameters related to the handover procedure in order t reduce signaling overhead and reduce an interruption time associated with the handover. For example, as shown in FIG. 4, a first UE 120 (shown as UE1) and a second UE 120 (shown as UE2) may be connected to a source cell and moving together in a direction 420 away from the source cell and toward a target cell. For example, the first UE 120 and the second UE 120 may be different devices that belong to the same user, such as a smartphone and a smartwatch, devices that belong to different users in the same vehicle, or devices that are engaged in V2X communication and both traveling in direction 420. Accordingly, where the first UE 120 and the second UE 120 are both connected to the source cell, the first UE 120 and the second UE 120 may be configured with the same mobility-related parameters, and both UEs 120 may perform a handover to the target cell. However, in the non-collaborative scenario 410, where the UEs 120 do not share communication parameters, the UEs 120 each perform the handover independently. For example, the first UE 120 performs a RACH-based handover 430 to the target cell, and the second UE 120 separately performs a RACH-based handover 440 to the target cell.

Accordingly, because the UEs 120 moving together perform the handover independently and without sharing any parameters, signaling overhead may be increased because the source cell sends a handover message to each UE 120 and communicates with the target cell to facilitate both handovers 430 and 440. In addition, the UEs 120 performing independently increases the interruption time for one or more UEs 120, because each UE 120 performs a RACH procedure in the target cell. In some aspects, in the collaborative scenario 450, the UEs 120 may share one or more parameters related to the handover procedure to reduce the signaling overhead and handover interruption time. For example, when the first UE 120 performs the first RACH-based handover 430 to the target cell, the first UE 120 may obtain a timing advance value during the RACH procedure to synchronize with the target cell. Accordingly, in the collaborative scenario 450, the first UE 120 may share the timing advance value with the second UE 120, such that the second UE 120 may reuse the timing advance value obtained by the first UE 120 to perform a RACH-less handover 460. In this way, the signaling overhead is reduced and the handover interruption time is reduced for the second UE 120 performing the RACH-less handover 460.

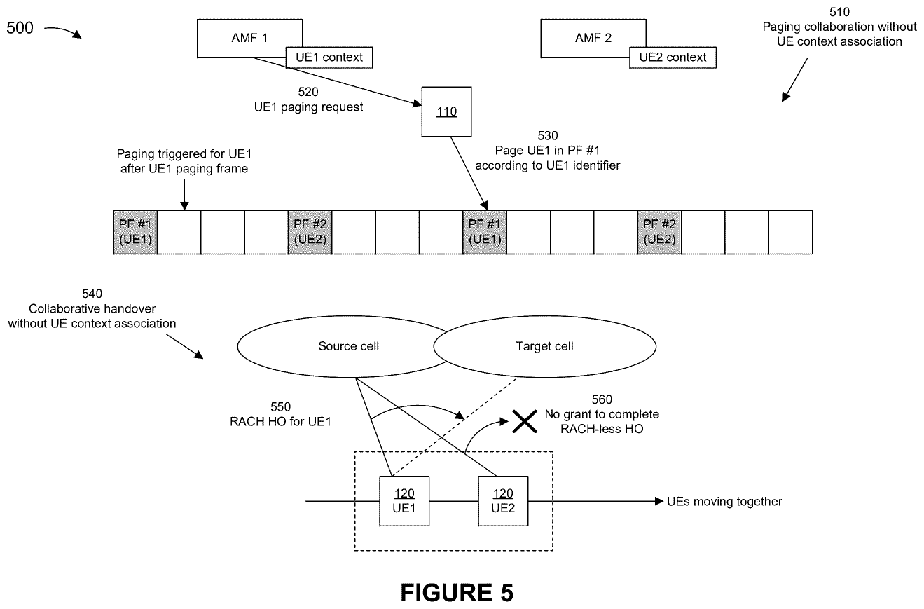

FIG. 5 is a diagram illustrating examples 500 associated with UE collaboration without associating UE contexts at one or more network entities. As described herein, FIG. 5 illustrates example collaborative scenarios 510 and 540 where multiple UEs (for example, a first UE and a second UE) may share resources, parameters, or other information associated with communicating in a wireless network. For example, FIG. 5 illustrates an example collaborative scenario 510 related to sharing paging resources among UEs 120 operating in an idle or inactive state in order to reduce paging latency (for example, by allowing a target UE 120 to be paged in a paging frame or paging occasion configured for any other UE 120 collaborating with the target UE 120, as described above with reference to FIG. 3). In another example, FIG. 5 illustrates an example collaborative scenario 540 related to sharing parameters related to a handover among UEs 120 operating in a connected state in order to reduce signaling overhead or handover interruption time for one or more UEs 120 (for example, by allowing a first UE 120 to share one or more parameters obtained during a handover procedure with a second UE 120 such that the second UE 120 can reuse the parameters obtained by the first UE 120, as described above with reference to FIG. 4).

As described herein, the collaborative scenarios 510 and 540 may fail because contexts associated with the collaborating UEs 120 are not associated at a network-level. For example, in the collaborative scenario 510, where multiple UEs 120 are sharing paging resources (for example, paging frames or paging occasions), one or more network entities may not know that the UEs 120 are collaborating and sharing the paging resources. For example, the collaborating UEs 120 may be connected to the same network node 110 (for example, a CU or DU), and the network node 110 may communicate with a first AMF that stores a UE context for the first UE 120 and a second AMF that stores a UE context for the second UE 120. Accordingly, a network entity that initiates paging to a target UE 120 may not have access to the UE contexts associated with other collaborating UEs 120, and therefore cannot trigger the paging in a paging frame or paging occasion configured for a (different) UE 120 collaborating with the target UE 120. For example, as shown in FIG. 5, the first AMF storing the UE context for the first UE 120 may send a paging request 520 for the first UE 120 to the network node 110, and the network node 110 may transmit a paging message to the first UE 120 using the paging resource 530 configured for the first UE 120. Accordingly, because the network node 110 does not have the UE context associated with the second UE 120 and does not know that the UEs 120 are collaborating to share paging resources, the network node 110 cannot transmit the paging message using the paging resource configured for the second UE 120.

Similarly, in the collaborative scenario 540, where multiple UEs 120 are sharing parameters related to a handover (for example, a timing advance value obtained during a RACH procedure), one or more network entities may not know that the UEs 120 are collaborating and sharing the handover parameters. For example, the collaborating UEs 120 may be connected to the same source cell and the first UE 120 may perform a RACH-based handover 550 from the source cell to the target cell. During the RACH-based handover 550, the first UE 120 obtains a timing advance value for the target cell, and provides the timing advance value to the second UE 120. However, because the collaboration among the UEs 120 is unknown at a network-level, the source cell does not notify the target cell that the second UE 120 will reuse the timing advance value that the first UE 120 obtained during the RACH-based handover 550. Rather, the target cell may expect the second UE 120 to send a RACH preamble, and therefore does not provide the second UE 120 with an uplink grant to complete a RACH-less handover. Accordingly, as shown by reference number 560, the second UE 120 may fail to complete the handover to the target cell before a timer expires, which may trigger a fallback in which the second UE 120 reverts to the source cell due to the timer expiring while the second UE 120 waits for communication from the target cell.

Accordingly, when a network node 110 does not know that different UEs 120 are collaborating, a UE collaboration scenario may fail or may otherwise utilize shared resources, parameters, or other information in a suboptimal manner. For example, in a scenario where a network node 110 does not know that multiple UEs 120 are sharing downlink resources or occasions, the network node 110 may be unable to send a downlink communication to a first UE 120 using a downlink resource or occasion configured for a second UE 120. In another example, where a first UE 120 shares parameters associated with a network procedure with a second UE 120, the network node 110 may not provide the second UE 120 with one or more resources (such as an uplink grant) that would allow the second UE 120 to complete the network procedure. Accordingly, in scenarios where a network node 110 has not associated the contexts for multiple UEs 120 in a UE collaboration group, the collaboration scenario may not improve relevant KPI targets to the optimal extent or the collaboration scenario may fail entirely or potentially degrade performance with respect to one or more targeted KPIs.

Various aspects relate generally to group context management for UE collaboration. Some aspects more specifically relate to one or more UEs 120 indicating a collaboration context associated with a UE collaboration group to a network node 110, such that the network node 110 may associate the contexts for the UEs 120 in the UE collaboration group and support the collaboration context associated with the UE collaboration group. For example, in some aspects, one or more UEs 120 in the UE collaboration group may indicate individual UE contexts associated with one or more UEs 120 in the UE collaboration group to the network node 110, or may indicate a group identifier associated with the various individual UE contexts to the network node 110. In some examples, where the UE collaboration group is associated with a group identifier, an application server or other network entity may indicate the group identifier to each UE 120 in the UE collaboration group, the UEs 120 in the UE collaboration group may communicate to coordinate selecting the group identifier, or one UE 120 in the UE collaboration group may obtain the group identifier from the network node 110 and share the group identifier with other UEs 120 in the UE collaboration group. In some aspects, after the collaboration context is indicated to the network node 110, one or more UE contexts may be transferred between network nodes 110 such that contexts associated with different UEs 120 are stored at a single network node 110. Additionally or alternatively, UEs 120 in the collaboration group may indicate the collaboration context when registering on a wireless network, such that the same network entity is selected to store the contexts associated with all UEs 120 in the collaboration group. In some aspects, additional techniques may relate to group context management may include authorizing the collaboration context and indicating the collaboration context periodically or when one or more events occur in order to maintain the collaboration context at a network-level, among other examples.

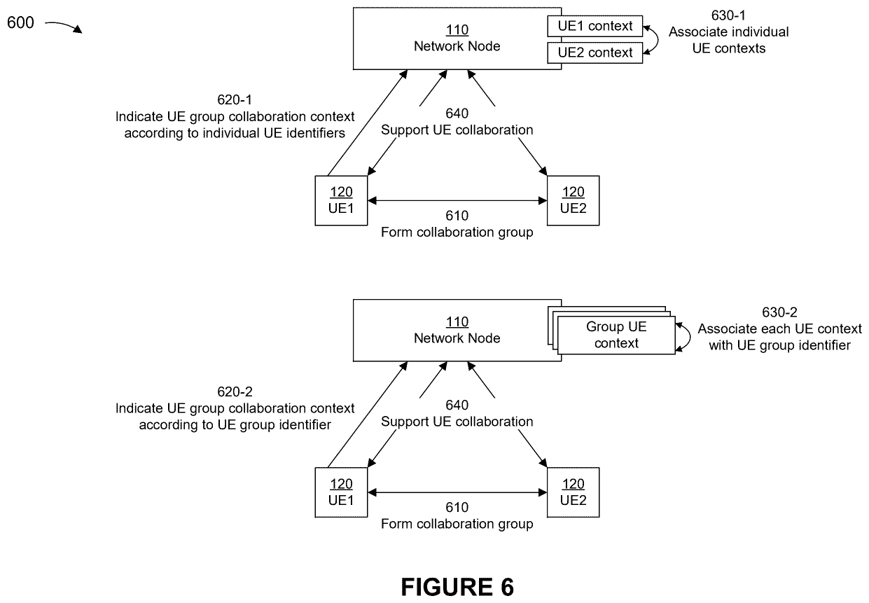

FIG. 6 is a diagram illustrating examples 600 associated with indicating a collaboration context associated with a UE collaboration group to a network node 110 to enable or more UE collaboration scenarios. As shown in FIG. 6, example 600 includes communication between a network node 110 and multiple UEs 120 in a UE collaboration group. For example, FIG. 6 illustrates communication between a network node 110 and a UE collaboration group that includes a first UE 120 and a second UE 120 (although the UE collaboration group may include more than two UEs 120). In some aspects, the network node 110 and the UEs 120 may communicate in a wireless network, such as wireless network 100. The network node 110 and the UEs 120 may communicate via a wireless access link that includes an uplink and a downlink.

In some aspects, in a first operation 610, multiple UEs 120 may form a UE collaboration group. For example, the UE collaboration group may include multiple UEs 120 that are associated with the same user, such as a smartphone, a smartwatch, smartglasses, an AI pin, a tablet, a laptop computer, or other suitable devices that belong to the same user. In other examples, a UE collaboration group may include multiple UEs 120 that are associated with a group of users, such as different devices that belong to different users in the same household, social group, or other group of users. In some aspects, where the UE collaboration group includes UEs 120 that belong to the same user or UEs 120 that otherwise have an existing association, the UE collaboration may be defined offline and one or more policies may be configured to define or control the collaboration scenario. For example, the UE collaboration group may include a primary UE 120 such that the primary UE 120 may handle one or more operations to connect to a wireless network or perform other procedures and share appropriate resources, parameters, or other information with other UEs 120 in the UE collaboration group. In another example, where the primary UE 120 is unavailable or not in proximity to the other UEs 120 in the UE collaboration group, a policy may be configured to designate the primary UE 120 for one or more subsets of the devices in the UE collaboration group, or the primary UE 120 may be selected according to a dynamic policy (for example, based on a battery level or processing capability). In such examples, where the various UEs 120 in the UE collaboration group belong to the same user or separate users in another trusted context, security issues may be handled at an application level or another appropriate level by the user(s). Alternatively, in some aspects, a UE collaboration group may include multiple UEs that are not associated with a trusted context (for example, proximal devices that belong to different users that do not know each other). In some aspects, the UE collaboration group may be formed according to a suitable discovery protocol, such as an over-the-air wireless local area network (WLAN) or Wi-Fi protocol, a wireless personal area network (WPAN) or Bluetooth protocol, or an over-the-top (OTT) location server protocol. In some aspects, the multiple UEs 120 in the UE collaboration group may collaborate in any suitable wireless communication scenario, such as sharing resources, parameters, or other suitable information related to communicating in a wireless network.

In some aspects, in a second operation 620, one or more UEs 120 in the UE collaboration group may transmit, to the network node 110, an indication related to the collaboration context associated with the UE collaboration group. In some aspects, in a first option 620-1, the indication may include an individual UE context associated with one or more other UEs 120 in the UE collaboration group. In such examples, individual context identifiers associated with the one or more other UEs 120 may be provided to the UE 120 that indicates the collaboration context to the network node 110 (for example, directly from the UE 120 associated with the context identifier, or indirectly from an application server). Accordingly, the UE 120 may transmit the context identifier associated with each UE 120 in the UE collaboration group to the network node 110 to indicate the collaboration context associated with the UE collaboration group. In addition, each UE 120 in the UE collaboration group may communicate with the network node 110 to obtain a UE context identifier, which may enable the network node 110 to obtain the UE context identifier for other UEs 120 upon receiving indications of the UE context identifiers for the other UEs 120 from a first UE 120. Alternatively, in a second option 620-2, the indication may include a group context identifier, where the group context identifier includes or is associated with individual context identifiers for the various UEs 120 in the UE collaboration group. In such examples, the group context identifier may be established or maintained among the UEs 120 in the UE collaboration group or at the network node 110.

In some aspects, the collaboration context associated with the UE collaboration group may be indicated to the network node 110 at periodic intervals, or in accordance with one or more triggering events. For example, in some aspects, the collaboration context associated with the UE collaboration group may be indicated to the network node 110 when collaboration among the UEs 120 starts, stops, or resumes, or when there is a change (for example, an addition or deletion) in the UEs 120 forming the UE collaboration group, among other examples. Additionally or alternatively, the indication may be provided when the UE 120 is in a connected state, or prior to a connection release to an idle or inactive state. In this way, the collaboration context may be persistent across multiple connectivity states, including a connected state and one or more disconnected states (for example, idle or inactive states). Furthermore, although FIG. 6 illustrates examples where one UE 120 (for example, a primary UE 120) indicates the collaboration context associated with the UE collaboration group to the network node 110, the collaboration context may be indicated by each UE 120 in the UE collaboration group, any UE 120 in the UE collaboration group, a specific UE 120 designated or delegated to indicate the collaboration context, a new UE 120 that joins the UE collaboration group, or a UE 120 exiting the UE collaboration group, among other examples. In some aspects, in addition to indicating the individual UE context identifiers or group context identifier associated with the UE collaboration group, the indication may include information related to a type of collaboration (for example, resources, parameters, or other information shared by the UE collaboration group).

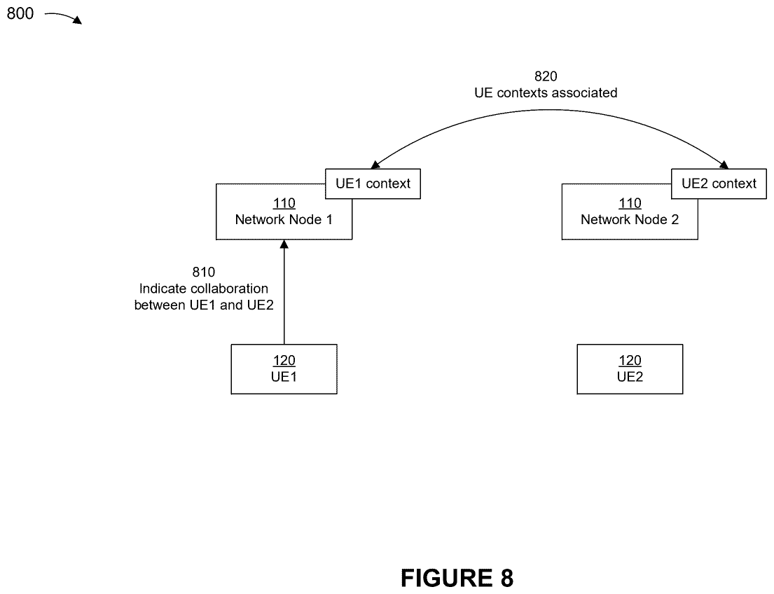

In some aspects, in a third operation 630, the network node 110 may associate the contexts for the UE collaboration group with one another For example, in a first option 630-1, where the collaboration context is indicated according to individual UE context identifiers, the network node 110 may associate the individual UE context identifiers with one another. Alternatively, in a second option 630-2, where the collaboration context is indicated according to a group context identifiers, the network node 110 may associate the individual UE context identifiers with the group context identifier. In some aspects, the UE contexts may be associated at the network node 110, or may be associated or shared across one or more network interfaces. For example, as described in more detail with reference to FIGS. 8-10, information about the group context identifier and/or individual UE context identifiers may be shared between a network node 110 and one or more core network entities, such as one or more AMFS, between a first network node 110 and a second network node 110, such as a CU and a DU, or in connection with one or more procedures, such as handover procedures or paging procedures, among other examples.

In some aspects, in a fourth operation 640, the network node 110 may support or otherwise facilitate the UE collaboration context. For example, in some aspects, the network node 110 authorize or may communicate with one or more other network entities (for example, core network entities) to authorize collaboration within the UE collaboration group. In some aspects, the collaboration may be authorized within the UE collaboration group in accordance with receiving the indication related to the collaboration context, with respect to a specific collaboration scheme or scenario, with respect to a specific geographical area (for example, a tracking area or cell), a specific time period, or one or more connectivity states, among other examples. In some aspects, the network node 110 may transmit information related to an authorization status to one or more UEs 120 in the UE collaboration group, or may transmit information indicating that collaboration within the UE collaboration group is deauthorized for one or more UEs 120 or all UEs 120 in the UE collaboration group. In some aspects, the authorization information may indicated in one or more policies, RRC signaling, NAS signaling, system information, or other suitable signaling. In some aspects, in examples where collaboration is authorized within the UE collaboration group, the network node 110 and other network entities may share information related to the associated UE contexts such that network activities are appropriately configured according to the resources, parameters, or other information shared among the UEs 120.

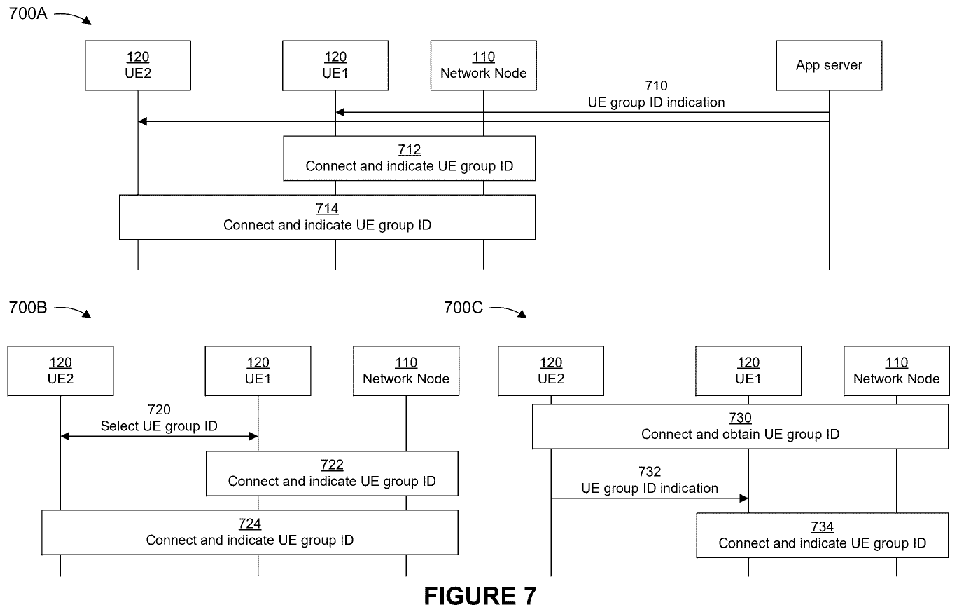

FIG. 7 is a diagram illustrating examples 700A, 700B, and 700C associated with establishing and indicating a UE group collaboration context to a network node 110 to enable or more UE collaboration scenarios. As shown in FIG. 7, examples 700A, 700B, and 700C include communication between a network node 110 and multiple UEs 120 in a UE collaboration group. For example, FIG. 7 illustrates communication between a network node 110 and a UE collaboration group that includes at least a first UE 120 and a second UE 120 (although the UE collaboration group may include more than two UEs 120). In some aspects, the network node 110 and the UEs 120 may communicate in a wireless network, such as wireless network 100. The network node 110 and the UEs 120 may communicate via a wireless access link that includes an uplink and a downlink. Furthermore, as shown in FIG. 7, example 700A additionally includes communication with an application server.

In some aspects, as described herein, one or more UEs 120 in the UE collaboration group may transmit, to the network node 110, an indication related to the collaboration context associated with the UE collaboration group. For example, the indication may include a group context identifier that includes or is associated with individual context identifiers for the various UEs 120 in the UE collaboration group. For example, the group context identifier may include an AMF identifier, a slice identifier, an identifier associated with a primary UE 120, or a token, among other examples. In some aspects, different techniques may be used to establish and maintain the group context identifier, as described herein.

For example, referring to example 700A, in a first operation 710, the application server may provide the group identifier to each UE 120 in the UE collaboration group. Accordingly, in some aspects, each UE 120 in the UE collaboration group may then connect to the network node 110 independently and indicate the group identifier. For example, in a second operation 712, the first UE 120 connects to the network node 110 and indicates the group identifier associated with the UE collaboration group. In a third operation 714, the second UE 120 connects to the network node 110 and indicates the group identifier associated with the UE collaboration group, and such group identifier indications may be similarly provided by any other UEs 120 in the UE collaboration group upon connection to the network node 110. In some aspects, in example 700A, collisions among group identifiers for different UE collaboration groups may be avoided by having the application server issue unique group identifiers to each UE collaboration group. Additionally or alternatively, collisions among group identifiers for different UE collaboration groups may be avoided through coordination between the application server and the network node 110.

Additionally or alternatively, referring to example 700B, in a first operation 720, the UEs 120 in the UE collaboration group may communicate with each other to coordinate or otherwise select the group identifier. Accordingly, each UE 120 in the UE collaboration group may similarly connect to the network node 110 and indicate the group identifier to the network node 110. For example, the first UE 120 connects to the network node 110 and indicates the group identifier associated with the UE collaboration group in a second operation 722, the second UE 120 connects to the network node 110 and indicates the group identifier associated with the UE collaboration group in a third operation 724, and such group identifier indications may be similarly provided by any other UEs 120 in the UE collaboration group upon connection to the network node 110. In some aspects, in example 700B, collisions among group identifiers for different UE collaboration groups may be minimized by having the UEs 120 select a random value as the group identifier or using other suitable rules or techniques to ensure that the group identifier is unique (for example, based on hardware addresses associated with the UEs 120 or other information that would be distinct in any other collection of multiple UEs 120).

Additionally or alternatively, referring to example 700C, in a first operation 730, one UE 120 in the UE collaboration group may connect to the network node 110 to obtain the group identifier. For example, in example 700C, the second UE 120 connects to the network node 110 and requests the group identifier from the network node 110, where the request may indicate ongoing or intended collaboration with other UEs 120. Accordingly, the network node 110 may provide the group identifier to the requesting UE 120 in accordance with the ongoing or intended collaboration with other UEs 120. In a second operation 732, the UE 120 that obtained the group identifier may directly or indirectly indicate the group identifier to other UEs 120 in the UE collaboration group. Accordingly, each UE 120 in the UE collaboration group may similarly connect to the network node 110 and indicate the group identifier to the network node 110. For example, in a third operation 734, the first UE 120 connects to the network node 110 and indicates the group identifier associated with the UE collaboration group, and such group identifier indications may be similarly provided by any other UEs 120 in the UE collaboration group upon connection to the network node 110. In some aspects, in example 700C, the group identifier may be an AMF identifier, an identifier of the UE 120 that requested and obtained the group identifier, or a token to be provided by the other collaborative UEs 120 upon registration with the network node 110.

In some aspects, in examples 700A, 700B, and 700C, the group identifiers for one or more UE collaboration groups may be managed at a network-level through the application server. For example, upon initial formation of a UE collaboration group, an AMF may send a message to the application server for initial selection of the group identifier. In some aspects, the request from the AMF may include a request to add a UE 120 with a given UE identifier to a UE collaboration group indicated according to a group identifier (or to remove a UE 120 with a given UE identifier from a UE collaboration group indicated according to a group identifier). In some aspects, the AMF may obtain, from the application server, the UE identifiers for a set of UEs 120 associated with a UE collaboration group according to the associated group identifier, and the application may provide information indicating a set of UE identifiers for the UEs 120 in the UE collaboration group.

FIG. 8 is a diagram illustrating an example 800 associated with transferring one or more contexts associated with a UE collaboration group after one or more UEs 120 indicate a UE collaboration context to a network node 110. As shown in FIG. 8, example 800 includes communication between network nodes 110 and multiple UEs 120 in a UE collaboration group. For example, FIG. 7 illustrates communication between a first network node 110 and a first UE 120, a second network node 110 and a second UE 120, and between the first network node 110 and the second network node 110. In some aspects, the network nodes 110 and the UEs 120 may communicate in a wireless network, such as wireless network 100. The network nodes 110 and the UEs 120 may communicate via a wireless access link that includes an uplink and a downlink. Furthermore, the network nodes 110 may communicate via a backhaul, midhaul, fronthaul, or other suitable interface.

As shown in FIG. 8, contexts associated with different UEs 120 in a UE collaboration group may be stored at separate network entities. For example, as shown in FIG. 8, a first network node 110 may store a UE context for a first UE 120, and a second network node 110 may store a UE context for a second UE 120. Accordingly, in a first operation 810, the first UE 120 may indicate a collaboration context associated with the UE collaboration group to the first network node 110, and the indication may indicate the UE context for the second UE 120 and further indicate the second network node 110 where the UE context for the second UE 120 is stored. For example, the indication may include or may be structured similar to a temporary identification number (TMSI) that includes an AMF identifier, or an inactive radio network temporary identifier (I-RNTI) or other identifier that can be uniquely mapped to a network node 110 (for example, via backhaul coordination among network nodes 110 via an Xn or other suitable interface). Accordingly, in a second operation 820, the first network node 110 may resolve the identity of the second network node 110 from the context identifier that the first UE 120 provides for the second UE 120 (for example, via a separate entity, such as an application server or core network entity). Furthermore, in the second operation 820, one or more UE contexts may be relocated such that all UE contexts are stored at a single network node 110. For example, in some aspects, the second operation 820 may include a context push to transfer the UE context associated with the first UE 120 to the network node 110 that stores the UE context associated with the second UE 120 or a context pull to transfer the UE context associated with the second UE 120 to the network node 110 that stores the UE context associated with the first UE 120. In some aspects, when one or more UE contexts are transferred to a different network node 110, a reconfiguration may be performed for the one or more UEs 120 associated with the UE contexts that were transferred to other network nodes 110.

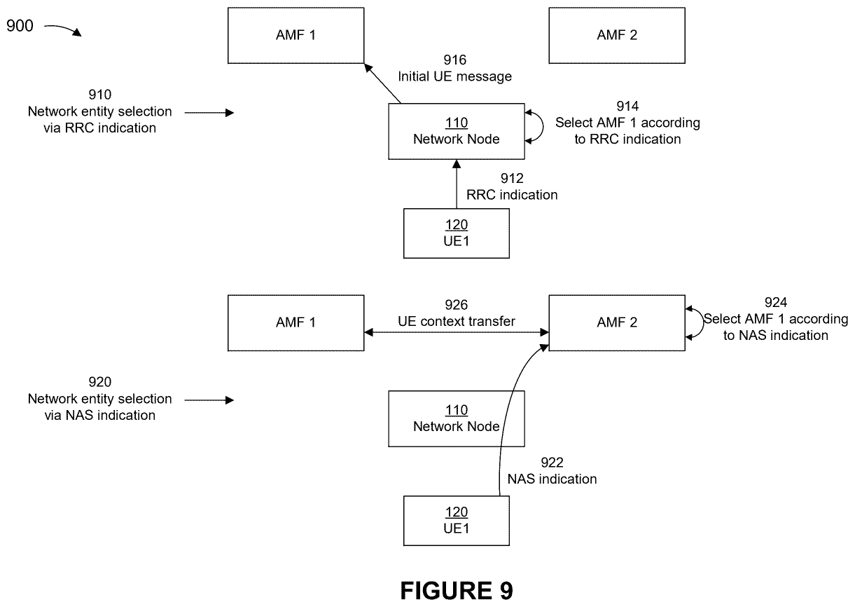

FIG. 9 is a diagram illustrating an example 900 associated with transferring one or more contexts associated with a UE collaboration group after one or more UEs 120 indicate a UE collaboration context to a network node 110. As shown in FIG. 9, example 900 includes communication between a network node 110, a UE 120 in a UE collaboration group, and multiple AMFs. In some aspects, the network node 110 and the UE 120 may communicate in a wireless network, such as wireless network 100. The network node 110 and the UE 120 may communicate via a wireless access link that includes an uplink and a downlink. Furthermore, the network node 110 may communicate with the AMFs via a backhaul interface.

As described herein, when contexts associated with different UEs 120 in a UE collaboration group are stored at separate network entities, one or more UE contexts may be transferred or relocated such that all UE contexts are stored at a single network node 110. Accordingly, to reduce the overhead associated with transferring UE contexts and reconfiguring UEs 120 whose UE contexts are relocated, example 900 relates to techniques whereby UEs 120 in a UE collaboration group provide the same or a similar indication of a collaboration context to a network node 110 such that the same network entity (for example, AMF) is selected to store the UE context associated with each UE 120 in the UE collaboration group.

For example, in a first option 910, the network node 110 may select an AMF or other network entity to store the UE context associated with each UE 120 in the UE collaboration group according to RRC signaling. For example, in a first operation 912, the UE 120 may provide the indication of the collaboration context to the network node 110 via RRC signaling in connection with registration on a wireless network, where the indication may include an AMF identifier, an identifier associated with the UE collaboration group, a slice identifier, or another suitable identifier. In some aspects, in a second operation 914, the network node 110 may then select the AMF to store the UE context associated with the UE 120 according to the RRC indication. For example, in FIG. 9, the network node 110 selects the first AMF, and forwards the initial message from the UE 120 to the first AMF in a third operation 916 according to the RRC indication. For example, in some aspects, the network node 110 may select the first AMF in accordance with the first AMF storing UE contexts for one or more other UEs 120 in the UE collaboration group.

Alternatively, in a first option 920, the AMF or other network entity to store the UE context associated with each UE 120 in the UE collaboration group may be selected according to NAS signaling. For example, in a first operation 922, the UE 120 may provide the indication of the collaboration context to the network node 110 via NAS signaling in connection with registration on a wireless network, and the NAS signaling may be routed to the second AMF (for example, according to an initial AMF selection protocol). In some aspects, the indication of the collaboration context may include an AMF identifier, an identifier associated with the UE collaboration group, a slice identifier, or another suitable identifier. In some aspects, in a second operation 924, the AMF where the NAS signaling is routed may then select an AMF to store the UE context associated with the UE 120. For example, in FIG. 9, the second AMF selects the first AMF, and relocates a UE context associated with the UE 120 to the first AMF in a third operation 926. For example, in some aspects, the second AMF may select the first AMF in accordance with the first AMF storing UE contexts for one or more other UEs 120 in the UE collaboration group.

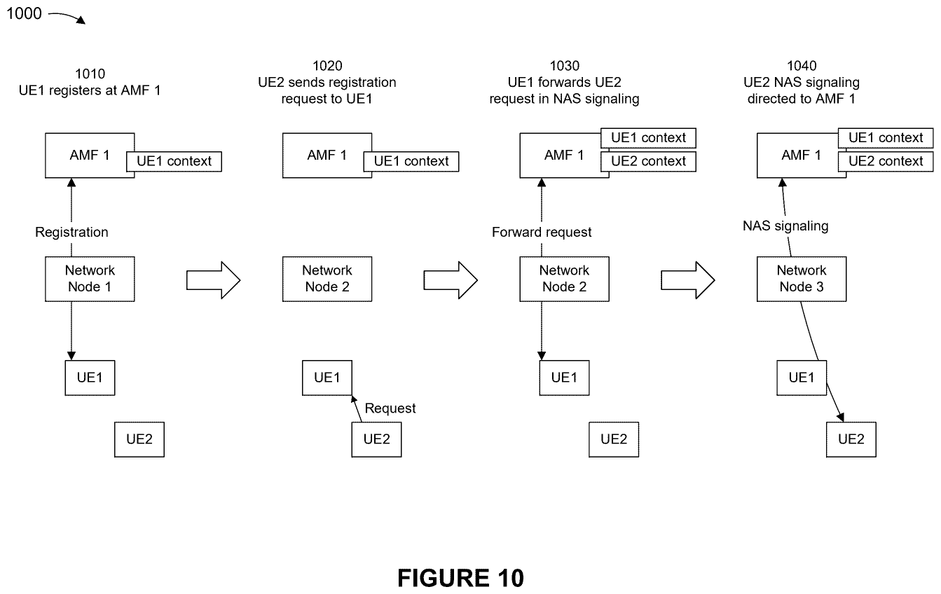

FIG. 10 is a diagram illustrating an example 1000 associated with storing contexts associated with a UE collaboration group at a common network entity. As shown in FIG. 10, example 1000 includes communication between multiple network nodes 110, UEs 120 in a UE collaboration group, and an AMF. In some aspects, the network node 110 and the UE 120 may communicate in a wireless network, such as wireless network 100. The network node 110 and the UE 120 may communicate via a wireless access link that includes an uplink and a downlink. Furthermore, the network node 110 may communicate with the AMF via a backhaul interface.

As described herein, when contexts associated with different UEs 120 in a UE collaboration group are stored at separate network entities, one or more UE contexts may be transferred or relocated such that all UE contexts are stored at a single network node 110. Accordingly, to reduce the overhead associated with transferring UE contexts and reconfiguring UEs 120 whose UE contexts are relocated, example 1000 relates to techniques whereby UE contexts associated with UEs 120 in a UE collaboration group are stored at the same network entity (for example, the same AMF).

For example, in a first state 1010, a first UE 120 and a second UE 120 are connected to a first network node, and the first UE 120 may transmit a registration message to register at the AMF. In some aspects, the AMF then stores a UE context for the first UE, and all subsequent NAS signaling for the first UE 120 is routed to the first UE 120 until any context relocation is performed.

In some aspects, in a second state 1020, the first UE 120 and the second UE 120 have moved from the coverage of the first network node 110 to the coverage of a second network node 110, but the UE context associated with the first UE 120 is still stored at the same AMF. In the second state 1020, the second UE 120 may transmit a registration request to the first UE 120 (for example, as a container).

In some aspects, in a third state 1030, the first UE 120 forwards the registration request from the second UE 120 to the AMF as a container within NAS signaling associated with the first UE 120. The AMF may then extract the container from the NAS signaling associated with the first UE and create a UE context for the second UE 120 to complete the registration for the second UE 120. Furthermore, the AMF assumes that the first UE and the second UE are in a UE collaboration group in accordance with receiving the NAS signaling for the second UE 120 from the first UE 120. Alternatively, the NAS signaling for the second UE 120 may be transported to the AMF using user plane signaling associated with the first UE 120.

In a fourth state 1040, the first UE 120 and the second UE 120 have moved from the coverage of the second network node 110 to the coverage of a third network node 110, but the UE contexts associated with the first UE 120 and the second UE 120 are still stored at the same AMF. Accordingly, in the fourth state 1040, NAS signaling associated with the first UE 120 toward the AMF may be direct (for example, not included in the NAS signaling or user plane signaling associated with the first UE 120).

FIG. 11 is a flowchart illustrating an example process 1100 performed, for example, at a UE or an apparatus of a UE that supports sharing wireless communication resources, wireless communication parameters, or other suitable information related to communication in a wireless network. Example process 1100 is an example where the apparatus or the UE (for example, UE 120) performs operations associated with group context management for UE collaboration.

As shown in FIG. 11, in some aspects, process 1100 may include communicating, within a UE collaboration group, information related to sharing one or more of a resource or a parameter associated with communication in a wireless network (block 1110). For example, the UE (such as by using communication manager 150 or collaboration component 1310, depicted in FIG. 13) may communicate, within a UE collaboration group, information related to sharing one or more of a resource or a parameter associated with communication in a wireless network, as described above.

As further shown in FIG. 11, in some aspects, process 1100 may include transmitting, to a network node, an indication related to a collaboration context associated with the UE collaboration group, wherein the collaboration context is persistent across multiple connectivity states including one or more disconnected states associated with the wireless network (block 1120). For example, the UE (such as by using communication manager 150 or transmission component 1304, depicted in FIG. 13) may transmit, to a network node, an indication related to a collaboration context associated with the UE collaboration group, wherein the collaboration context is persistent across multiple connectivity states including one or more disconnected states associated with the wireless network, as described above.

Process 1100 may include additional aspects, such as any single aspect or any combination of aspects described below or in connection with one or more other processes described elsewhere herein.

In a first additional aspect, the indication includes one or more context identifiers associated with one or more collaborative UEs in the UE collaboration group.

In a second additional aspect, alone or in combination with the first aspect, process 1100 includes receiving the one or more context identifiers associated with the one or more collaborative UEs from the one or more collaborative UEs or from an application server.

In a third additional aspect, alone or in combination with one or more of the first and second aspects, the indication includes a group identifier associated with the UE collaboration group.

In a fourth additional aspect, alone or in combination with one or more of the first through third aspects, process 1100 includes receiving the group identifier associated with the UE collaboration group from an application server.

In a fifth additional aspect, alone or in combination with one or more of the first through fourth aspects, process 1100 includes communicating with one or more collaborative UEs in the UE collaboration group to establish the group identifier associated with the UE collaboration group.

In a sixth additional aspect, alone or in combination with one or more of the first through fifth aspects, process 1100 includes receiving the group identifier associated with the UE collaboration group from a collaborative UE in the UE collaboration group.

In a seventh additional aspect, alone or in combination with one or more of the first through sixth aspects, the indication related to the collaboration context includes information related to a network location where contexts associated with one or more UEs in the UE collaboration group are stored.

In an eighth additional aspect, alone or in combination with one or more of the first through seventh aspects, the indication related to the collaboration context is included in RRC signaling.

In a ninth additional aspect, alone or in combination with one or more of the first through eighth aspects, the indication related to the collaboration context is included in NAS signaling.

In a tenth additional aspect, alone or in combination with one or more of the first through ninth aspects, process 1100 includes receiving, from the network node, information related to an authorization status for the collaboration context associated with the UE collaboration group.

In an eleventh additional aspect, alone or in combination with one or more of the first through tenth aspects, the indication related to the collaboration context is transmitted one or more of periodically or in accordance with one or more triggering events.

In a twelfth additional aspect, alone or in combination with one or more of the first through eleventh aspects, the UE collaboration group is associated with one or more policies that configure the collaboration context for multiple UEs included in the UE collaboration group.

In a thirteenth additional aspect, alone or in combination with one or more of the first through twelfth aspects, process 1100 includes joining the UE collaboration group according to a discovery protocol.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, at a network node or an apparatus of a network node that supports one or more collaboration scenarios in which a UE collaboration group shares wireless communication resources, wireless communication parameters, or other suitable information related to communication in a wireless network. Example process 1200 is an example where the apparatus or the network node (for example, network node 110) performs operations associated with group context management for UE collaboration.

As shown in FIG. 12, in some aspects, process 1200 may include receiving an indication related to a collaboration context associated with a UE collaboration group sharing one or more of a resource or a parameter associated with communication in a wireless network, wherein the collaboration context is persistent across multiple connectivity states including one or more disconnected states associated with the wireless network (block 1210). For example, the network node (such as by using communication manager 150 or reception component 1402, depicted in FIG. 14) may receive an indication related to a collaboration context associated with a UE collaboration group sharing one or more of a resource or a parameter associated with communication in a wireless network, wherein the collaboration context is persistent across multiple connectivity states including one or more disconnected states associated with the wireless network, as described above.

As further shown in FIG. 12, in some aspects, process 1200 may include configuring an association among individual UE contexts for a set of UEs in the UE collaboration group in accordance with the collaboration context (block 1220). For example, the network node (such as by using communication manager 150, reception component 1402, or transmission component 1404, depicted in FIG. 14) may configure an association among individual UE contexts for a set of UEs in the UE collaboration group in accordance with the collaboration context, as described above.

Process 1200 may include additional aspects, such as any single aspect or any combination of aspects described below or in connection with one or more other processes described elsewhere herein.

In a first additional aspect, the indication includes one or more context identifiers associated with one or more collaborative UEs in the UE collaboration group.

In a second additional aspect, alone or in combination with the first aspect, the indication includes a group identifier associated with the UE collaboration group.

In a third additional aspect, alone or in combination with one or more of the first and second aspects, process 1200 includes receiving, from a first UE, a request for the group identifier associated with the UE collaboration group, transmitting the group identifier to the first UE, and associating a first context associated with the first UE with a second context associated with a second UE from which the indication related to the collaboration context is received.

In a fourth additional aspect, alone or in combination with one or more of the first through third aspects, the indication related to the collaboration context includes information related to a network location where contexts associated with one or more UEs in the UE collaboration group are stored.

In a fifth additional aspect, alone or in combination with one or more of the first through fourth aspects, process 1200 includes communicating over a backhaul to relocate the contexts associated with the one or more UEs in the UE collaboration group at a single network location.

In a sixth additional aspect, alone or in combination with one or more of the first through fifth aspects, the indication related to the collaboration context is included in RRC signaling.

In a seventh additional aspect, alone or in combination with one or more of the first through sixth aspects, process 1200 includes selecting an AMF in accordance with the collaboration context included in the RRC signaling.

In an eighth additional aspect, alone or in combination with one or more of the first through seventh aspects, the indication related to the collaboration context is included in NAS signaling.

In a ninth additional aspect, alone or in combination with one or more of the first through eighth aspects, process 1200 includes communicating over a backhaul to relocate the contexts associated with the one or more UEs in the UE collaboration group at an AMF in accordance with the NAS signaling.

In a tenth additional aspect, alone or in combination with one or more of the first through ninth aspects, process 1200 includes transmitting, to one or more UEs in the UE collaboration group, information related to an authorization status for the collaboration context associated with the UE collaboration group.

In an eleventh additional aspect, alone or in combination with one or more of the first through tenth aspects, the indication related to the collaboration context is received one or more of periodically or in accordance with one or more triggering events.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication that supports sharing wireless communication resources, wireless communication parameters, or other suitable information related to communication in a wireless network. The apparatus 1300 may be a UE, or a UE may include the apparatus 1300. In some aspects, the apparatus 1300 includes a reception component 1302, a transmission component 1304, and a communication manager 1306, which may be in communication with one another (for example, via one or more buses). As shown, the apparatus 1300 may communicate with another apparatus 1308 (such as a UE 120, a network node 110, or another wireless communication device) using the reception component 1302 and the transmission component 1304. The communication manager 1306 may be included in, or implemented via, a processing system (for example, the processing system 140). In some aspects, the communication manager 1306 is the communication manager 150.

In some aspects, the apparatus 1300 may be configured to or operable to perform one or more operations described herein in connection with FIGS. 3-4 or FIGS. 6-10. Additionally or alternatively, the apparatus 1300 may be configured to or operable to perform one or more processes described herein, such as process 1100 of FIG. 11.

The reception component 1302 may receive communications, such as reference signals, control information, or data communications, from the apparatus 1308. The reception component 1302 may provide received communications to one or more other components of the apparatus 1300, such as the communication manager 1306. In some aspects, the reception component 1302 may perform signal processing on the received communications, and may provide the processed signals to the one or more other components in a similar manner as described above in connection with FIG. 1. In some aspects, the reception component 1302 may include one or more components of the UE 120 described above in connection with FIG. 1, such as a radio, one or more RF chains, one or more transceivers, or one or more modems, each of which may in turn be coupled with one or more antennas of the UE 120.

The transmission component 1304 may transmit communications, such as reference signals, control information, or data communications, to the apparatus 1308. In some aspects, the communication manager 1306 may generate communications and may transmit the generated communications to the transmission component 1304 for transmission to the apparatus 1308. In some aspects, the transmission component 1304 may perform signal processing on the generated communications, and may transmit the processed signals to the apparatus 1308 in a similar manner as described above in connection with FIG. 1. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE. In some aspects, the transmission component 1304 may be co-located with the reception component 1302.

The communication manager 1306 may communicate, within a UE collaboration group, information related to sharing one or more of a resource or a parameter associated with communication in a wireless network. The communication manager 1306 may transmit or may cause the transmission component 1304 to transmit, to a network node, an indication related to a collaboration context associated with the UE collaboration group, wherein the collaboration context is persistent across multiple connectivity states including one or more disconnected states associated with the wireless network. In some aspects, the communication manager 1306 may perform one or more operations described elsewhere herein as being performed by one or more components of the communication manager 1306.

In some aspects, the communication manager 1306 includes a set of components, such as a collaboration component 1310. Alternatively, the set of components may be separate and distinct from the communication manager 1306. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The collaboration component 1310 may communicate, within a UE collaboration group, information related to sharing one or more of a resource or a parameter associated with communication in a wireless network. The transmission component 1304 may transmit, to a network node, an indication related to a collaboration context associated with the UE collaboration group, wherein the collaboration context is persistent across multiple connectivity states including one or more disconnected states associated with the wireless network.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication that supports one or more collaboration scenarios in which a UE collaboration group shares wireless communication resources, wireless communication parameters, or other suitable information related to communication in a wireless network. The apparatus 1400 may be a network node 110, or a network node 110 may include the apparatus 1400. In some aspects, the apparatus 1400 includes a reception component 1402, a transmission component 1404, and a communication manager 1406, which may be in communication with one another (for example, via one or more buses). As shown, the apparatus 1400 may communicate with another apparatus 1408 (such as a UE 120, a network node 110, or another wireless communication device) using the reception component 1402 and the transmission component 1404. The communication manager 1406 may be included in, or implemented via, a processing system (for example, the processing system 145). In some aspects, the communication manager 1406 is the communication manager 155

In some aspects, the apparatus 1400 may be configured to or operable to perform one or more operations described herein in connection with FIGS. 3-4 or FIGS. 6-10. Additionally or alternatively, the apparatus 1400 may be configured to or operable to perform one or more processes described herein, such as process 1200 of FIG. 12.

The reception component 1402 may receive communications, such as reference signals, control information, or data communications, from the apparatus 1408. The reception component 1402 may provide received communications to one or more other components of the apparatus 1400, such as the communication manager 1406. In some aspects, the reception component 1402 may perform signal processing on the received communications, and may provide the processed signals to the one or more other components in a similar manner as described above in connection with FIG. 1. In some aspects, the reception component 1402 may include one or more components of the network node 110 described above in connection with FIG. 1, such as a radio, one or more RF chains, one or more transceivers, or one or more modems, each of which may in turn be coupled with one or more antennas of the network node 110.

The transmission component 1404 may transmit communications, such as reference signals, control information, or data communications, to the apparatus 1408. In some aspects, the communication manager 1406 may generate communications and may transmit the generated communications to the transmission component 1404 for transmission to the apparatus 1408. In some aspects, the transmission component 1404 may perform signal processing on the generated communications, and may transmit the processed signals to the apparatus 1408 in a similar manner as described above in connection with FIG. 1. In some aspects, the transmission component 1404 may include one or more components of the network node 110 described above in connection with FIG. 1, such as a radio, one or more RF chains, one or more transceivers, or one or more modems, each of which may in turn be coupled with one or more antennas of the network node 110. In some aspects, the transmission component 1404 may be co-located with the reception component 1402.

The communication manager 1406 may receive or may cause the reception component 1402 to receive an indication related to a collaboration context associated with a UE collaboration group sharing one or more of a resource or a parameter associated with communication in a wireless network, wherein the collaboration context is persistent across multiple connectivity states including one or more disconnected states associated with the wireless network. The communication manager 1406 may configure an association among individual UE contexts for a set of UEs 120 in the UE collaboration group in accordance with the collaboration context. In some aspects, the communication manager 1406 may perform one or more operations described elsewhere herein as being performed by one or more components of the communication manager 1406.

In some aspects, the communication manager 1406 includes a set of components. Alternatively, the set of components may be separate and distinct from the communication manager 1406. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1402 may receive an indication related to a collaboration context associated with a UE collaboration group sharing one or more of a resource or a parameter associated with communication in a wireless network, wherein the collaboration context is persistent across multiple connectivity states including one or more disconnected states associated with the wireless network. The reception component 1402 or the transmission component 1404 may configure an association among individual UE contexts for a set of UEs in the UE collaboration group in accordance with the collaboration context.

The quantity and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

Aspect 1: A method for wireless communication by a UE, comprising: communicating, within a UE collaboration group, information related to sharing one or more of a resource or a parameter associated with communication in a wireless network; and transmitting, to a network node, an indication related to a collaboration context associated with the UE collaboration group, wherein the collaboration context is persistent across multiple connectivity states including one or more disconnected states associated with the wireless network.

Aspect 2: The method of Aspect 1, wherein the indication includes one or more context identifiers associated with one or more collaborative UEs in the UE collaboration group.

Aspect 3: The method of Aspect 2, further comprising: receiving the one or more context identifiers associated with the one or more collaborative UEs from the one or more collaborative UEs or from an application server.

Aspect 4: The method of any of Aspects 1-3, wherein the indication includes a group identifier associated with the UE collaboration group.

Aspect 5: The method of Aspect 4, further comprising: receiving the group identifier associated with the UE collaboration group from an application server.

Aspect 6: The method of Aspect 4, further comprising: communicating with one or more collaborative UEs in the UE collaboration group to establish the group identifier associated with the UE collaboration group.

Aspect 7: The method of Aspect 4, further comprising: receiving the group identifier associated with the UE collaboration group from a collaborative UE in the UE collaboration group.

Aspect 8: The method of any of Aspects 1-7, wherein the indication related to the collaboration context includes information related to a network location where contexts associated with one or more UEs in the UE collaboration group are stored.

Aspect 9: The method of any of Aspects 1-8, wherein the indication related to the collaboration context is included in RRC signaling.

Aspect 10: The method of any of Aspects 1-9, wherein the indication related to the collaboration context is included in NAS signaling.

Aspect 11: The method of any of Aspects 1-10, further comprising: receiving, from the network node, information related to an authorization status for the collaboration context associated with the UE collaboration group.

Aspect 12: The method of any of Aspects 1-11, wherein the indication related to the collaboration context is transmitted one or more of periodically or in accordance with one or more triggering events.

Aspect 13: The method of any of Aspects 1-12, wherein the UE collaboration group is associated with one or more policies that configure the collaboration context for multiple UEs included in the UE collaboration group.

Aspect 14: The method of any of Aspects 1-13, further comprising: joining the UE collaboration group according to a discovery protocol.

Aspect 15: A method of wireless communication performed by a network node, comprising: receiving an indication related to a collaboration context associated with a UE collaboration group sharing one or more of a resource or a parameter associated with communication in a wireless network, wherein the collaboration context is persistent across multiple connectivity states including one or more disconnected states associated with the wireless network; and configuring an association among individual UE contexts for a set of UEs in the UE collaboration group in accordance with the collaboration context.

Aspect 16: The method of Aspect 15, wherein the indication includes one or more context identifiers associated with one or more collaborative UEs in the UE collaboration group.

Aspect 17: The method of any of Aspects 15-16, wherein the indication includes a group identifier associated with the UE collaboration group.

Aspect 18: The method of Aspect 17, further comprising: receiving, from a first UE, a request for the group identifier associated with the UE collaboration group; transmitting the group identifier to the first UE; and associating a first context associated with the first UE with a second context associated with a second UE from which the indication related to the collaboration context is received.

Aspect 19: The method of any of Aspects 15-18, wherein the indication related to the collaboration context includes information related to a network location where contexts associated with one or more UEs in the UE collaboration group are stored.

Aspect 20: The method of Aspect 17, further comprising: communicating over a backhaul to relocate the contexts associated with the one or more UEs in the UE collaboration group at a single network location.

Aspect 21: The method of any of Aspects 15-20, wherein the indication related to the collaboration context is included in RRC signaling.

Aspect 22: The method of Aspect 19, further comprising: selecting an AMF in accordance with the collaboration context included in the RRC signaling.

Aspect 23: The method of any of Aspects 15-22, wherein the indication related to the collaboration context is included in NAS signaling.

Aspect 24: The method of Aspect 21, further comprising: communicating over a backhaul to relocate the contexts associated with the one or more UEs in the UE collaboration group at an AMF in accordance with the NAS signaling.

Aspect 25: The method of any of Aspects 15-24, further comprising: transmitting, to one or more UEs in the UE collaboration group, information related to an authorization status for the collaboration context associated with the UE collaboration group.

Aspect 26: The method of any of Aspects 15-25, wherein the indication related to the collaboration context is received one or more of periodically or in accordance with one or more triggering events.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
communicate, within a UE collaboration group, information related to sharing one or more of a resource or a parameter associated with communication in a wireless network; and
transmit, to a network node, an indication related to a collaboration context associated with the UE collaboration group, wherein the collaboration context is persistent across multiple connectivity states including one or more disconnected states associated with the wireless network.

2. The UE of claim 1, wherein the indication includes one or more context identifiers associated with one or more collaborative UEs in the UE collaboration group.

3. The UE of claim 2, wherein the processing system is further configured to cause the UE to:
receive the one or more context identifiers associated with the one or more collaborative UEs from the one or more collaborative UEs or from an application server.

4. The UE of claim 1, wherein the indication includes a group identifier associated with the UE collaboration group.

5. The UE of claim 4, wherein the processing system is further configured to cause the UE to:
receive the group identifier associated with the UE collaboration group from an application server.

6. The UE of claim 4, wherein the processing system is further configured to cause the UE to:
communicate with one or more collaborative UEs in the UE collaboration group to establish the group identifier associated with the UE collaboration group.

7. The UE of claim 4, wherein the processing system is further configured to cause the UE to:
receive the group identifier associated with the UE collaboration group from a collaborative UE in the UE collaboration group.

8. The UE of claim 1, wherein the indication related to the collaboration context includes information related to a network location where contexts associated with one or more UEs in the UE collaboration group are stored.

9. The UE of claim 1, wherein the indication related to the collaboration context is included in radio resource control (RRC) signaling.

10. The UE of claim 1, wherein the indication related to the collaboration context is included in non-access stratum (NAS) signaling.

11. The UE of claim 1, wherein the processing system is further configured to cause the UE to:
receive, from the network node, information related to an authorization status for the collaboration context associated with the UE collaboration group.

12. The UE of claim 1, wherein the indication related to the collaboration context is transmitted one or more of periodically or in accordance with one or more triggering events.

13. The UE of claim 1, wherein the UE collaboration group is associated with one or more policies that configure the collaboration context for multiple UEs included in the UE collaboration group.

14. The UE of claim 1, wherein the processing system is further configured to cause the UE to:
join the UE collaboration group according to a discovery protocol.

15. A network node, comprising:
a processing system that includes one or more processors and one or more code-storing memories coupled with the one or more processors, the processing system configured to cause the network node to:
receive an indication related to a collaboration context associated with a user equipment (UE) collaboration group sharing one or more of a resource or a parameter associated with communication in a wireless network, wherein the collaboration context is persistent across multiple connectivity states including one or more disconnected states associated with the wireless network; and
configure an association among individual UE contexts for a set of UEs in the UE collaboration group in accordance with the collaboration context.

16. The network node of claim 15, wherein the indication includes one or more context identifiers associated with one or more collaborative UEs in the UE collaboration group.

17. The network node of claim 15, wherein the indication includes a group identifier associated with the UE collaboration group.

18. The network node of claim 17, wherein the processing system is further configured to cause the network node to:
receive, from a first UE, a request for the group identifier associated with the UE collaboration group;
transmit the group identifier to the first UE; and
associate a first context associated with the first UE with a second context associated with a second UE from which the indication related to the collaboration context is received.

19. The network node of claim 15, wherein the indication related to the collaboration context includes information related to a network location where contexts associated with one or more UEs in the UE collaboration group are stored.

20. The network node of claim 17, wherein the processing system is further configured to cause the network node to:
communicate over a backhaul to relocate the contexts associated with the one or more UEs in the UE collaboration group at a single network location.

21. The network node of claim 15, wherein the indication related to the collaboration context is included in radio resource control (RRC) signaling.

22. The network node of claim 21, wherein the processing system is further configured to cause the network node to:
select an access and mobility management function (AMF) in accordance with the collaboration context included in the RRC signaling.

23. The network node of claim 15, wherein the indication related to the collaboration context is included in non-access stratum (NAS) signaling.

24. The network node of claim 23, wherein the processing system is further configured to cause the network node to:
communicate over a backhaul to relocate the contexts associated with the one or more UEs in the UE collaboration group at an access and mobility management function (AMF) in accordance with the NAS signaling.

25. The network node of claim 15, wherein the processing system is further configured to cause the network node to:
transmit, to one or more UEs in the UE collaboration group, information related to an authorization status for the collaboration context associated with the UE collaboration group.

26. The network node of claim 15, wherein the indication related to the collaboration context is received one or more of periodically or in accordance with one or more triggering events.

27. A method for wireless communication by a user equipment (UE), comprising:
communicating, within a UE collaboration group, information related to sharing one or more of a resource or a parameter associated with communication in a wireless network; and
transmitting, to a network node, an indication related to a collaboration context associated with the UE collaboration group, wherein the collaboration context is persistent across multiple connectivity states including one or more disconnected states associated with the wireless network.

28. The method of claim 27, wherein the indication includes one or more context identifiers associated with one or more collaborative UEs in the UE collaboration group or a group identifier associated with the UE collaboration group.

29. A method for wireless communication by a network node, comprising:
receiving an indication related to a collaboration context associated with a user equipment (UE) collaboration group sharing one or more of a resource or a parameter associated with communication in a wireless network, wherein the collaboration context is persistent across multiple connectivity states including one or more disconnected states associated with the wireless network; and
configure an association among individual UE contexts for a set of UEs in the UE collaboration group in accordance with the collaboration context.

30. The method of claim 29, wherein the indication includes one or more context identifiers associated with one or more collaborative UEs in the UE collaboration group or a group identifier associated with the UE collaboration group.
